(19) United States
(12) Patent Application Publication
(10) Pub. No.: US 2007/0104132 A1
(43) Pub. Date: May 10, 2007

(54) Techniques capable of providing efficient scheduling of packet data traffic in wireless data networks

(76) Inventors: Bala Rajagopalan, Beaverton, OR (US); Roshni M. Srinivasan, Palo Alto, CA (US); Muthaiah Venkatachalam, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/269,398

(22) Filed: Nov. 7, 2005

(51) Int. Cl. H04Q 7/00

(52) U.S. Cl. 370/329

(57) ABSTRACT

An embodiment of the present invention provides a method comprising, using packet knowledge at a base station to efficiently schedule uplink transmissions from a subscriber station. The present method may further comprise using the type of packet and the destination subscriber station as the packet knowledge and, further, the type of packet may include voice, data or signaling and each of the types of packet may be given a packet classifier.

### BACKGROUND

Wireless communications, including wireless networks, have become pervasive throughout society. Improvements in wireless communications are vital to increase their reliability and speed. Wireless communications may include voice and/or data and may have uplink and down link transmissions from a base station (BS) to and from subscriber stations (SS).

Currently, voice traffic is allocated a fixed bandwidth in uplink and downlink directions. Optimizing capacity allocation for silence-suppressed voice, for example, requires timely stopping and starting of uplink bandwidth scheduling. Currently proposed methods are based on explicit SS actions for doing this, and they either incur bandwidth overheads or delays. The methods used for this typically are periodic polling, whereby each SS is allocated some bandwidth in the uplink direction periodically to request resources, or contention-based requests, whereby each SS accesses shared bandwidth in the uplink direction on contention basis to do the same. Polling is a good technique to use when an SS has a steady stream of traffic to send (such as Voice over IP packets during a voice conversation). Contention request is good when the SS has to send bursty traffic occasionally. But periodic polling is wasteful of uplink bandwidth when an SS has no traffic to send uplink (for instance, during a silence-suppressed period in voice conversation). On the other hand, contention-based requests may result in a delay in getting uplink bandwidth allocated by the BS.

Thus, a strong need exists for techniques capable of providing efficient scheduling of packet data traffic in wireless data networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an embodiment of the present invention with anticipatory scheduling for an uplink which may be incorporated in the processing of downlink traffic.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN) and Mesh networks.

Some embodiments of the present invention provide an efficient centralized scheduling of Internet Protocol (IP) packets for transmission at a wireless base station (BS) that may be utilized in wireless networks (such as WiMax), where a base station (BS) schedules packet transmissions in both the uplink (subscriber station (SS) to BS) and the downlink (BS to SS) directions. It is understood that the present invention is not limited to any particular type of wireless network and particularly is not limited to a WiMax wireless network. Typically, a BS has complete knowledge of traffic flowing downlink and hence may schedule this with relative ease. On the other hand, information about the uplink traffic has to be collected by the BS from each SS in some manner. The methods used for this typically are periodic polling, whereby each SS is allocated some bandwidth in the uplink direction periodically to request resources, or contention-based requests, whereby each SS accesses shared bandwidth in the uplink direction on contention basis to do the same. As stated above, polling is a good technique to use when an SS has a steady stream of traffic to send (such as Voice over IP packets during a voice conversation). Contention request is good when the SS has to send bursty traffic occasionally. But periodic polling is wasteful of uplink bandwidth when an SS has no traffic to send uplink (for instance, during a silence-suppressed period in voice conversation). On the other hand, contention-based requests may result in a delay in getting uplink bandwidth allocated by the BS.

An embodiment of the present invention thus provides a method for “anticipatory scheduling”, which mitigates the problems of both these techniques in supporting IP-based packet traffic in the uplink direction. Although not limited in this respect, under anticipatory scheduling, the following characteristics of voice, data, and other application and control traffic may be leveraged:

Voice conversations may be half-duplex in the long term, i.e., when one party is speaking, the other is usually listening.

TCP/IP data traffic may be typically asymmetric, flowing mostly in the downlink direction with acknowledgements flowing in the uplink direction. TCP control state machines may be available with predictable interactions between the two ends.

Other applications based on UDP/IP may have well-known “request/response” semantics.

Thus, for voice, a BS may monitor downlink traffic, and when it detects silence, it may begin scheduling uplink transmission opportunities in anticipation of a change in direction. For data, the BS may schedule an uplink transmission opportunity for acknowledgements and other responses when it sends downlink TCP or UDP traffic. At other times, an SS utilizes contention-based requests for bandwidth access.

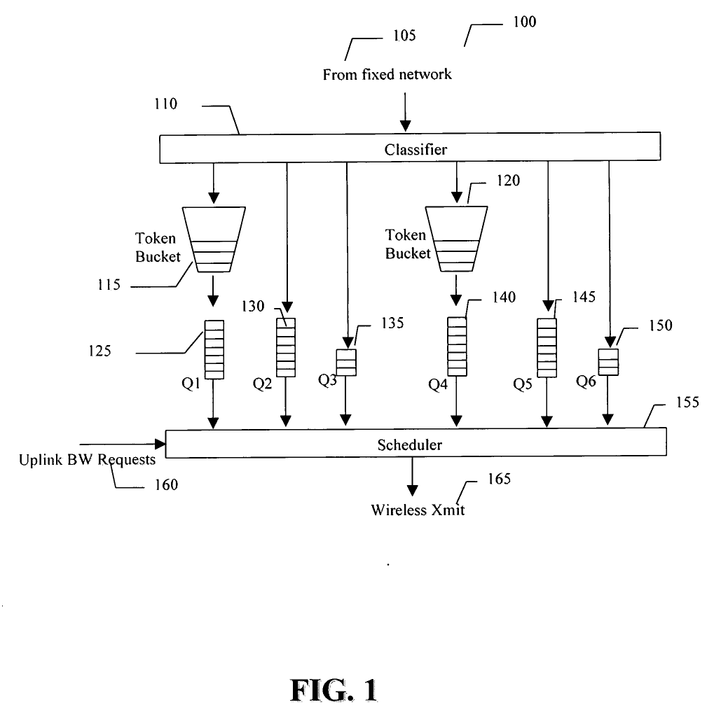

Turning now to FIG. 1, illustrated generally as 100, are the components of this system at the BS with anticipatory scheduling for the uplink which may be incorporated in the processing of downlink traffic. These components may include, although are not limited to:

A packet classifier 110 which may be in communication with a fixed network 105, which detects the type of packet (voice/data/signaling/other application) and the destination SS.

A multiplicity of queues 125, 130, 135, 140, 145 and 150 such that one queue per traffic class is assigned for each SS served. Although not limited to this number, FIG. 1 depicts six queues Q1-Q6 (125-150), assigned to two subscriber stations (Q1, 125-Q3, 135 to the first SS, Q4, 140-Q6, 150 to the second). The three traffic classes may be voice (Q2, 130 and Q5, 145), data (Q1, 125 and Q4, 140) and signaling (Q3, 135 and Q6, 150).

Token bucket 115 and 120 policing schemes for data traffic to enforce the rate at which the traffic is accepted for transmission 165.

A scheduler 155 at the BS that keeps track of the overall resource availability in the uplink and downlink directions, and allocates capacity for uplink and downlink transmissions.

From FIG. 1, it is seen that anticipatory scheduling for the uplink is incorporated in the processing of downlink traffic. Specifically, the classifier may look at various fields of an IP packet received from the fixed network to select a specific queue to place the packet in. The rate at which packets are added to different queues may depend on a token bucket policing mechanism, although the present invention is not limited in this respect. The scheduler may monitor the queues, and pick packets for downlink transmission. In doing so, the scheduler 155 decides the following:

Whether to start scheduling uplink transmission opportunity for a given SS, and if so, when and with what capacity. For voice traffic, the absence of downlink packets, or the presence of comfort noise descriptor packets in Q2 130 and Q5 145 during a predefined time interval would indicate silence. This would then trigger scheduling of increased uplink bandwidth 160 for the corresponding subscribers. Also, the presence of certain signaling packets in Q3 135 and Q6 150 may also trigger the scheduling of uplink voice transmission opportunities (this is the case for SS-initiated voice calls which typically start after signaling is completed). For data and signaling traffic, the presence of a certain number and type of packets in the corresponding queues would trigger the scheduling of a certain amount of bandwidth in the uplink direction. The amount of bandwidth thus scheduled in the uplink, and the duration of the schedule would depend on the type of application.

Whether to stop scheduling uplink transmission opportunity for a given SS. For voice traffic, the presence of a certain number of packets in Q2 130 and Q5 145 would indicate the beginning of a sustained talk spurt in the downlink direction. This would result in the scheduler 155 stopping or reducing the grant of uplink transmission opportunities to the subscriber.

Each SS may maintain a local classification and scheduling mechanism to separate voice and data traffic and enforce priority amongst them.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a base station capable of using packet knowledge to efficiently schedule uplink transmissions from a subscriber station.

2. The apparatus of claim 1, wherein said packet knowledge comprises the type of packet and the destination subscriber station (SS).

3. The apparatus of claim 2, wherein said type of packet includes voice, data, signaling or other application specific information and wherein each of said types of packet is given to a packet classifier.

4. The apparatus of claim 3, wherein said base station further comprises a plurality of queues such that one queue per type of packet is assigned for each SS served.

5. The apparatus of claim 4, wherein said type of packet corresponds to a given traffic class.

6. The apparatus of claim 3, further comprising a token bucket policing technique for data traffic to enforce the rate at which said data traffic is accepted for transmission.

7. The apparatus of claim 1, further comprising a scheduler at said BS that keeps track of overall resource availability in the uplink and downlink directions, and allocates capacity for uplink and downlink transmissions

8. The apparatus of claim 3, wherein when said packet classifier indicates voice traffic, said BS monitors downlink traffic, and when it detects silence, it begins scheduling uplink transmission opportunities in anticipation of a change in direction.

9. The apparatus of claim 3, wherein when said packet classifier indicates data traffic, said BS schedules an uplink transmission opportunity for acknowledgements and other responses when it sends downlink TCP or UDP traffic.

10. A method, comprising:
using downlink packet knowledge at a base station to efficiently schedule uplink transmissions from a subscriber station.

11. The method of claim 10, further comprising using the type of packet and the destination SS as said packet knowledge.

12. The method of claim 11, further comprising including voice, data or signaling as the type of packet and wherein each of said types of packet is given to a packet classifier.

13. The method of claim 11, further comprising assigning one queue by a BS per traffic class from a plurality of queues for each SS served.

14. The method of claim 13, wherein said traffic classes includes voice, data and signaling.

15. The method of claim 12, further comprising using a token bucket policing technique for data traffic to enforce the rate at which said data traffic is accepted for transmission.

16. The method of claim 10, further comprising using a scheduler at said BS that keeps track of overall resource availability in the uplink and downlink directions, and allocates capacity for uplink and downlink transmissions.

17. The method of claim 12, wherein when said packet classifier indicates downlink voice traffic and said BS detects silence, it begins scheduling uplink transmission opportunities in anticipation of a change in direction.

18. The method of claim 12, wherein when said packet classifier indicates data traffic, said BS schedules an uplink transmission opportunity for acknowledgements and other responses when it sends downlink TCP or UDP traffic.

19. A system, comprising:
a subscriber station in a wireless communication network; and
a base station capable of using downlink packet knowledge to schedule uplink transmissions from said subscriber station to said base station efficiently

20. The system of claim 19, wherein said packet knowledge comprises the type of packet and the destination SS.

21. The system of claim 20, wherein said type of packet includes voice, data, signaling and wherein each of said types of packet is given to a packet classifier.

22. The system of claim 21, further comprising a token bucket policing technique for data traffic to enforce the rate at which said data traffic is accepted for transmission.

23. A machine-accessible medium that provides instructions, which when accessed, cause a machine to perform operations comprising:
using packet knowledge at a base station to efficiently schedule uplink transmissions from a subscriber station.

24. The machine-accessible medium of claim 22, further comprising said instructions causing said machine to use the type of packet and the destination SS as said packet knowledge.

25. The machine-accessible medium of claim 23, further comprising said instructions causing said machine to include voice, data or signaling as the type of packet and giving each of said types of packet a packet classifier.

26. The machine-accessible medium of claim 23, further comprising said instructions causing said machine to assign at least one queue by a BS per traffic class from a plurality of queues for each SS served.

27. The machine-accessible medium of claim 23, further comprising said instructions causing said machine to use a token bucket policing technique for data traffic to enforce the rate at which said data traffic is accepted for transmission.

28. The machine-accessible medium of claim 22, further comprising said instructions causing said machine to use a scheduler at said BS that keeps track of overall resource availability in the uplink and downlink directions, and allocates capacity for uplink and downlink transmissions
